(19) United States
(12) Patent Application Publication
(10) Pub. No.: US 2026/0338198 A1
(43) Pub. Date: Oct. 29, 2026

(54) BLOWER

(71) Applicant: MAKITA CORPORATION, Anjo-shi (JP)

(72) Inventors: Yuki KOIDE, Anjo-shi (JP); Kunito Shindo, Anjo-shi (JP)

(73) Assignee: MAKITA CORPORATION, Anjo-shi (JP)

(21) Appl. No.: 19/641,955

(22) Filed: Apr. 8, 2026

(30) Foreign Application Priority Data
Apr. 14, 2025 (JP) 2025-066450

(51) Int. Cl. F04D 29/42; A01G 20/47; F04D 17/16; F04D 25/08

(52) U.S. Cl. CPC F04D 29/4206; A01G 20/47; F04D 17/16; F04D 25/08

(57) ABSTRACT

A blower may include: a fan; a prime mover configured to drive the fan; a housing that houses the fan and the prime mover; an airflow passage extending from the fan; and a distal opening disposed at a distal end of the airflow passage and communicating an interior and an exterior of the airflow passage with each other. When the fan is driven, air may be discharged from the interior to the exterior of the airflow passage through the distal opening, or air may be suctioned from the exterior to the interior of the airflow passage through the distal opening. There may be no obstruction between the distal opening and the fan inside the airflow passage. A diameter of a maximum inscribed circle of the distal opening may be less than or equal to 50 mm.

### CROSS REFERENCE TO RELATED APPLICATION

This application claims priority to Japanese Patent Application No. 2025-066450 filed on Apr. 14, 2025. The entire content of the priority application is incorporated herein by reference.

### TECHNICAL FIELD

The art disclosed herein relates to a blower.

### BACKGROUND ART

Japanese Patent Application Publication No. 2002-159924 describes a blower including: a fan; a prime mover configured to drive the fan; a housing that houses the fan and the prime mover; an airflow passage extending from the fan; and a distal opening disposed at a distal end of the airflow passage and communicating an interior and an exterior of the airflow passage with each other. When the fan is driven, air is discharged from the interior to the exterior of the airflow passage through the distal opening, or air is suctioned from the exterior to the interior of the airflow passage through the distal opening. There is no obstruction between the distal opening and the fan inside the airflow passage.

### SUMMARY

If each of the airflow passage and the distal opening is wide, a user's hand may enter the interior of the airflow passage through the distal opening and even reach the fan. To suppress this, an obstruction may be provided inside the airflow passage. However, when such an obstruction is installed inside the airflow passage, there is a risk that an object (e.g., dust) may get caught on the obstruction inside the airflow passage, and the object may stay inside the airflow passage. In this case, the user may have to remove the object from inside the airflow passage, which may deteriorate the usability of the blower. This specification provides a technology that can suppress a user's hand from reaching a fan while suppressing deterioration of blower usability.

A blower disclosed herein may comprise: a fan; a prime mover configured to drive the fan; a housing that houses the fan and the prime mover; an airflow passage extending from the fan; and a distal opening disposed at a distal end of the airflow passage and communicating an interior and an exterior of the airflow passage with each other. When the fan is driven, air may be discharged from the interior to the exterior of the airflow passage through the distal opening, or air may be suctioned from the exterior to the interior of the airflow passage through the distal opening. There may be no obstruction between the distal opening and the fan inside the airflow passage. A diameter of a maximum inscribed circle of the distal opening may be less than or equal to 50 mm.

Another blower disclosed herein may comprise: a fan; a prime mover configured to drive the fan; a housing that houses the fan and the prime mover; an airflow passage extending from the fan; and a distal opening disposed at a distal end of the airflow passage and communicating an interior and an exterior of the airflow passage with each other. When the fan is driven, air may be discharged from the interior to the exterior of the airflow passage through the distal opening, or air may be suctioned from the exterior to the interior of the airflow passage through the distal opening. There may be no obstruction between the distal opening and the fan inside the airflow passage. A diameter of a maximum inscribed circle in a cross section of at least one position of the airflow passage may be less than or equal to 50 mm.

The term “obstruction” as used herein refers to structure(s) that suppress object(s) from passing through the airflow passage (e.g., filter(s), net(s), and obstruction panel(s)).

### BRIEF DESCRIPTION OF DRAWINGS

FIG. 1 is a view of a blower 2 according to the first embodiment from a front upper left side.

FIG. 2 is a cross-sectional view of an internal structure of the blower 2 according to the first embodiment as seen from a left side, showing the divider 50 in the collection position.

FIG. 3 is a cross-sectional view of the internal structure of the blower 2 according to the first embodiment as seen from the left side, showing the divider 50 in the non-collection position.

FIG. 4 is a view of a centrifugal fan 26 in the blower 2 according to the first embodiment, viewed from the front upper left side.

FIG. 5 is a cross-sectional view of an air intake passage 72 and an air delivery passage 76 of the blower 2 according to the first embodiment, viewed from the left side.

FIG. 6 is a view of the blower 2 according to the first embodiment from a front side.

FIG. 7 is a view of a first distal opening 70 and a second distal opening 74 of the blower 2 according to the first embodiment, viewed from the front side.

FIG. 8 is a view of an air delivery configuration of a blower 102 according to the second embodiment, viewed from the front upper left side.

FIG. 9 is a view of a vacuum configuration of the blower 102 according to the second embodiment, viewed from the front upper left side.

FIG. 10 is a cross-sectional view of the internal structure of a handle 120 and a motor case 122 of the blower 102 according to the second embodiment, viewed from a right side.

FIG. 11 is a cross-sectional view of the internal structure of the motor case 122 and a fan case 124 of the blower 102 according to the second embodiment, viewed from the front side.

FIG. 12 is a cross-sectional view of an air delivery passage 152 of the blower 102 according to the second embodiment, viewed from the left side.

FIG. 13 is a view of a third distal opening 150 of the blower 102 according to the second embodiment, viewed from the front side.

FIG. 14 is a cross-sectional view of an air intake passage 156 of the blower 102 according to the second embodiment, viewed from a rear side.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved blowers, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

A blower disclosed herein may comprise: a fan; a prime mover configured to drive the fan; a housing that houses the fan and the prime mover; an airflow passage extending from the fan; and a distal opening disposed at a distal end of the airflow passage and communicating an interior and an exterior of the airflow passage with each other. When the fan is driven, air may be discharged from the interior to the exterior of the airflow passage through the distal opening, or air may be suctioned from the exterior to the interior of the airflow passage through the distal opening. There may be no obstruction between the distal opening and the fan inside the airflow passage. A diameter of a maximum inscribed circle of the distal opening may be less than or equal to 50 mm.

According to the above configuration, the distal opening is so narrow that a palm (or arm) of a user cannot pass through. This can suppress the user's palm (or arm) from entering the interior of the airflow passage through the distal opening, by which a user's hand can be suppressed from reaching the fan. Also, since there is no obstruction between the distal opening and the fan inside the airflow passage, object(s) (e.g., dust) can be suppressed from remaining inside the airflow passage. This can save the user from having to remove the object(s) from inside the airflow passage, by which usability of the blower can be suppressed from deteriorating. Thus, according to the above configuration, a user's hand can be suppressed from reaching the fan while the usability of the blower can be suppressed from deteriorating.

Another blower disclosed herein may comprise: a fan; a prime mover configured to drive the fan; a housing that houses the fan and the prime mover; an airflow passage extending from the fan; and a distal opening disposed at a distal end of the airflow passage and communicating an interior and an exterior of the airflow passage with each other. When the fan is driven, air may be discharged from the interior to the exterior of the airflow passage through the distal opening, or air may be suctioned from the exterior to the interior of the airflow passage through the distal opening. There may be no obstruction between the distal opening and the fan inside the airflow passage. A diameter of a maximum inscribed circle in a cross section of at least one position of the airflow passage may be less than or equal to 50 mm.

According to the above configuration, at least one part of the airflow passage is so narrow that the user's palm (or arm) cannot pass through. This can suppress a user's hand from reaching the fan. Also, since there is no obstruction between the distal opening and the fan inside the airflow passage, object(s) (e.g., dust) can be suppressed from remaining inside the airflow passage. This can save the user from having to remove the object(s) from inside the airflow passage, by which the usability of the blower can be suppressed from deteriorating. Thus, according to the above configuration, a user's hand can be suppressed from reaching the fan while the usability of the blower can be suppressed from deteriorating.

In one aspect of the present teachings, the diameter of the maximum inscribed circle may be more than or equal to 20 mm.

If the distal opening and/or the airflow passage is excessively narrow, the pressure loss generated at the distal opening and/or the airflow passage when air flows through the distal opening and/or the airflow passage may increase, and an air discharge flow rate by the blower or an air suction flow rate by the blower may decrease. According to the above configuration, the distal opening and/or the airflow passage can be suppressed from becoming excessively narrow, so that the pressure loss generated at the distal opening and/or the airflow passage when air flows through the distal opening and/or the airflow passage can be reduced. This allows the air discharge flow rate by the blower or the air suction flow rate by the blower to be increased. Furthermore, according to the above configuration, since the distal opening and/or the airflow passage is reasonably wide, it is possible to suppress suction-target object(s) (e.g., fallen leaves) that are to be suctioned together with the air from being caught in the distal opening and/or the airflow passage when air is suctioned by the blower. This allows the blower to suction the suction-target object(s) smoothly.

In one aspect of the present teachings, a length of a flow passage from the distal opening to the fan inside the airflow passage may be less than or equal to 850 mm.

According to the above configuration, the airflow passage is compact, allowing the user to easily handle the blower.

In one aspect of the present teachings, when the distal opening is viewed from the exterior of the airflow passage along a direction in which the airflow passage extends, the fan may be visible through the distal opening.

According to the above configuration, since the airflow passage between the distal opening and the fan is straight, the flow resistance is small. This can increase the air discharge flow rate by the blower or the air suction flow rate by the blower.

In one aspect of the present teachings, when the fan is driven, air may be suctioned from the exterior to the interior of the airflow passage through the distal opening.

According to the above configuration, when air is suctioned by the blower, object(s) (e.g., dust) are actively suctioned into the interior of the airflow passage. In this case, effect of having no obstruction between the distal opening and the fan inside the airflow passage (i.e., suppression of object(s) from remaining inside the airflow passage) can be significantly demonstrated.

In one aspect of the present teachings, the fan may be a centrifugal fan.

Centrifugal fans are more suitable for generating high pressure airflow than, for example, axial fans. Therefore, according to the above configuration, a blower that generates a high-pressure airflow, i.e., a blower with high suction power, can be easily realized.

In one aspect of the present teachings, the blower may further comprise a collection bag configured to be detachably attached to the housing such that the collection bag is disposed in the exterior of the housing and to collect an object suctioned together with air from the exterior to the interior of the airflow passage through the distal opening. A direction in which air is suctioned from the exterior to the interior of the airflow passage through the distal opening may be defined as a first direction. A direction opposite to the first direction may be defined as a second direction. When the collection bag is attached to the housing, an end of the distal opening in the second direction may be offset in the second direction relative to an end of the collection bag in the second direction.

When air is suctioned by the blower, the collection bag may flap as the collection bag is suctioned toward the distal opening together with the air. If the collection bag flaps, the user may feel that the collection bag is in the way. According to the above configuration, when air is suctioned by the blower, it can be suppressed that the collection bag is suctioned toward the distal opening together with the air. Since this can suppress the collection bag from flapping, the user can be suppressed from feeling that the collection bag is in the way. Furthermore, according to the above configuration, since the blower becomes compact, the user can easily handle the blower.

### First Embodiment: Blower 2

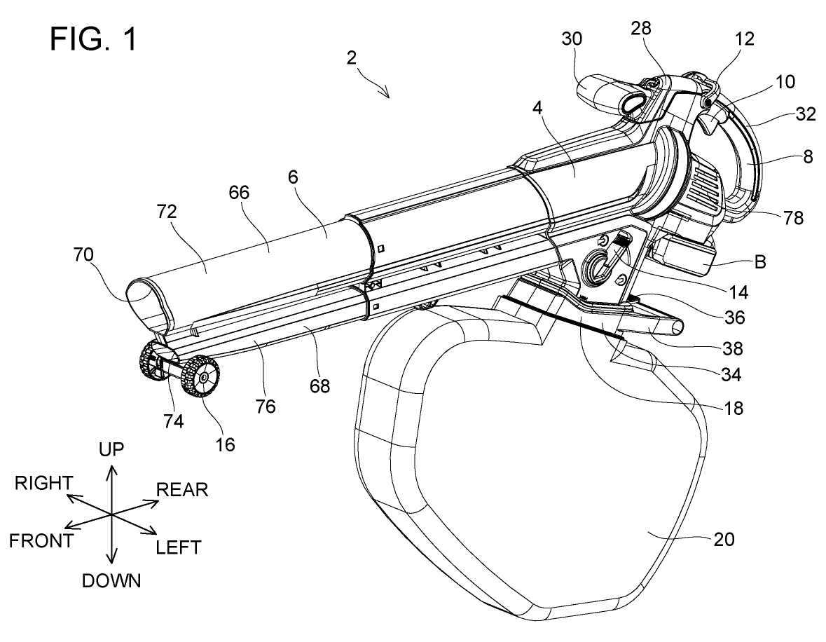

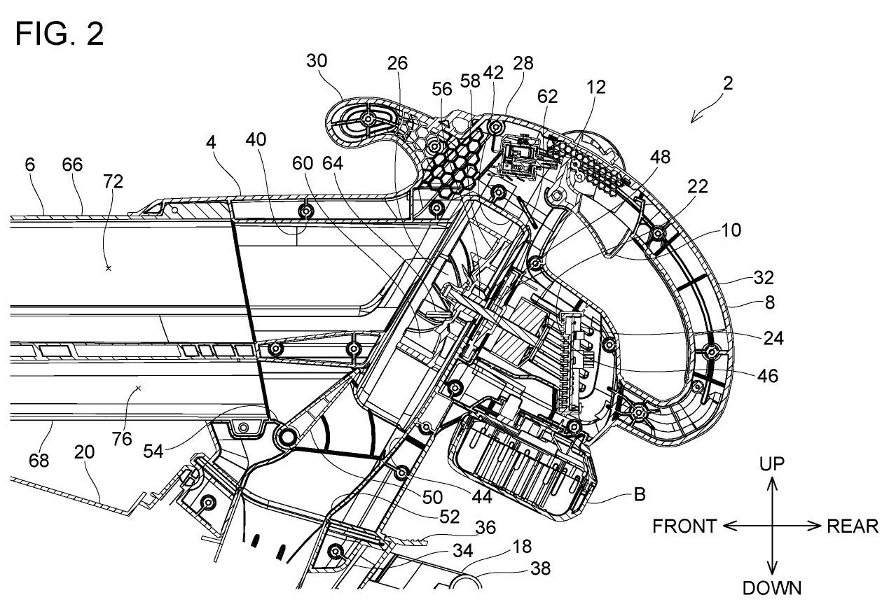

As shown in FIG. 1, the blower 2 comprises a housing 4, a nozzle 6, a handle 8, a trigger lever 10, a cruise control lever 12, a switching lever 14, a pair of wheels 16, a connecting member 18, a collection bag 20, an electric motor 22 (see FIG. 2), a control device 24 (see FIG. 2), and a centrifugal fan 26 (see FIG. 2). A battery pack B is detachably attached to a lower rear part of the housing 4. The battery pack B contains rechargeable secondary battery cell(s) (e.g., lithium-ion battery cell(s)). The blower 2 operates on the electric power supplied from the battery pack B. In this embodiment, a direction extending along the longitudinal direction of the nozzle 6 from the housing 4 to the nozzle 6 is a front direction, and the opposite direction thereof is a rear direction. A direction orthogonal to a front-rear direction and extending from the housing 4 to the collection bag 20 is a down direction, and the opposite direction thereof is an up direction. A direction orthogonal to front-rear and up-down directions and extending from the housing 4 to the switching lever 14 is a left direction, and the opposite direction thereof is a right direction.

The handle 8 comprises a base 28, a front gripping portion 30, and a rear gripping portion 32. The base 28 protrudes to a rear upper direction from the upper surface of the housing 4. The front gripping portion 30 extends to an up and front direction from the front surface of the base 28, then branches off and extends toward the right and left sides. The rear gripping portion 32 extends to a rear and down direction from the rear surface of the base 28, then bends to extend frontward, and connects to the rear surface of the housing 4. The user can carry the blower 2 by grasping the front gripping portion 30 with one hand and the rear gripping portion 32 with the other hand.

The pair of wheels 16 is rotatably attached to a lower part of the front end of the nozzle 6 (specifically, an air delivery nozzle 68). The user can easily move the front end of the nozzle 6 along the ground by having the pair of wheels 16 run on the ground with one hand grasping the front gripping portion 30 and the other hand grasping the rear gripping portion 32.

The connecting member 18 comprises a connecting portion 34, a lever portion 36, and a handle portion 38. The connecting portion 34 is detachably attached to a lower end part of the housing 4. The lever portion 36 is located at a rear end part of the connecting portion 34. The handle portion 38 extends rearward from the rear end part of the connecting portion 34. The user can remove the connecting member 18 from the housing 4 by pushing the lever portion 36 downward with one hand while grasping the handle portion 38 with the other hand. The collection bag 20 is attached to the connecting portion 34. The collection bag 20 is constituted of a mesh material. This allows air in the collection bag 20 to pass through the collection bag 20. The collection bag 20 collects debris suctioned by the blower 2.

As shown in FIG. 2, the housing 4 comprises an air intake chamber 40, a fan housing chamber 42, an air exhaust chamber 44, and a motor housing chamber 46. The air intake chamber 40 is connected to a front part of the fan housing chamber 42. The air exhaust chamber 44 is connected to a lower part of the fan housing chamber 42. The motor housing chamber 46 is connected to a rear part of the fan housing chamber 42.

The electric motor 22 and the control device 24 are housed in the motor housing chamber 46. The centrifugal fan 26 is housed in the fan housing chamber 42. In the motor housing chamber 46, the control device 24 is located rearward of the electric motor 22. The control device 24 provides electric power to the electric motor 22 using power supplied from the battery pack B. The control device 24 controls the output of the electric motor 22 by adjusting the power supplied to the electric motor 22. The electric motor 22 is, for example, a brushless motor. The electric motor 22 rotates the shaft 48. The shaft 48 extends across both the fan housing chamber 42 and the motor housing chamber 46. The shaft 48 is connected to the centrifugal fan 26.

The trigger lever 10 is located at a front part of the lower surface of the rear gripping portion 32. The user can operate the trigger lever 10 with the index finger of the hand grasping the rear gripping portion 32. When the user pushes in the trigger lever 10, electric power is supplied from the battery pack B to the electric motor 22, which drives the electric motor 22 and rotates the centrifugal fan 26. This causes the blower 2 to suction or discharge air. Upon doing so, the output of the electric motor 22 (i.e., rotation speed of the centrifugal fan 26) is adjusted according to an amount by which the trigger lever 10 is pushed in. When the user removes his/her hand from the trigger lever 10 and the trigger lever 10 is no longer pushed in, the supply of electric power from the battery pack B to the electric motor 22 is cut off, by which the suction or discharge of air by the blower 2 stops. The cruise control lever 12 is located near a connection point between the base 28 and the rear gripping portion 32. The user can move the cruise control lever 12 and secure it in a desired position to keep the trigger lever 10 pushed in by a desired amount. This allows the trigger lever 10 to remain pushed in even while a user’s hand is not on the trigger lever 10.

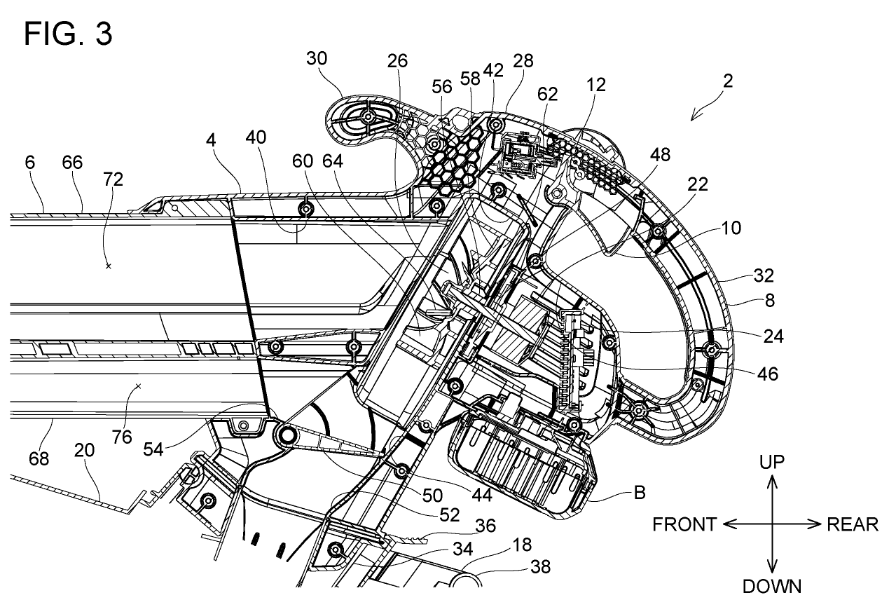

As shown in FIGS. 2 and 3, a divider 50 configured to rotate around an axis extending in a left-right direction relative to the housing 4 is disposed in the air exhaust chamber 44. The divider 50 divides the air exhaust chamber 44 into a first exhaust chamber 52 extending downward as viewed from the fan housing chamber 42 and a second exhaust chamber 54 extending frontward as viewed from the fan housing chamber 42. The divider 50 is operatively connected with the switching lever 14 (see FIG. 1) located on the outer surface of the handle 8. By operating the switching lever 14, the user can move the divider 50 between a collection position shown in FIG. 2 and a non-collection position shown in FIG. 3. As shown in FIG. 2, when the divider 50 is in the collection position, the interior space of the first exhaust chamber 52 communicates with the interior space of the fan housing chamber 42, and the interior space of the second exhaust chamber 54 does not communicate with the interior space of the fan housing chamber 42. As shown in FIG. 3, when the divider 50 is in the non-collection position, the interior space of the first exhaust chamber 52 does not communicate with the interior space of the fan housing chamber 42, and the interior space of the second exhaust chamber 54 communicates with the interior space of the fan housing chamber 42. Thus, the divider 50 can selectively switch between a state of communicating the interior space of the fan housing chamber 42 with the interior space of the first exhaust chamber 52 (i.e., the state shown in FIG. 2) and a state of communicating the interior space of the fan housing chamber 42 with the interior space of the second exhaust chamber 54 (i.e., the state shown in FIG. 3).

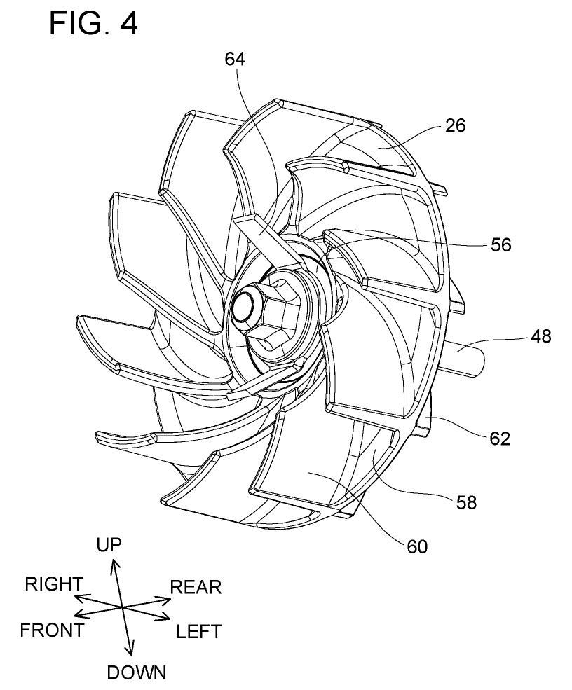

As shown in FIG. 4, the centrifugal fan 26 comprises an axial portion 56, a disk portion 58, a front vane portion 60, and a rear vane portion 62. The disk portion 58 extends from the outer peripheral surface of the axial portion 56 outward in the radial direction. The front vane portion 60 protrudes frontward from the front surface of the disk portion 58. The rear vane portion 62 protrudes rearward from the rear surface of the disk portion 58. The axial portion 56 is fixed to a front part of the shaft 48. Thus, the centrifugal fan 26 rotates in unison with the shaft 48. The front vane portion 60 of the centrifugal fan 26 rotates to suction air in front of the centrifugal fan 26 and send that air outward in the radial direction of the centrifugal fan 26. Similarly, the rear vane portion 62 of the centrifugal fan 26 rotates to suction air behind the centrifugal fan 26 and send that air outward in the radial direction of the centrifugal fan 26. A crushing blade 64 is fixed to the front end of the axial portion 56. The crushing blade 64 rotates in unison with the shaft 48. The crushing blade 64 is constituted of a metallic material (e.g., iron alloy). The crushing blade 64 crushes the debris as it rotates.

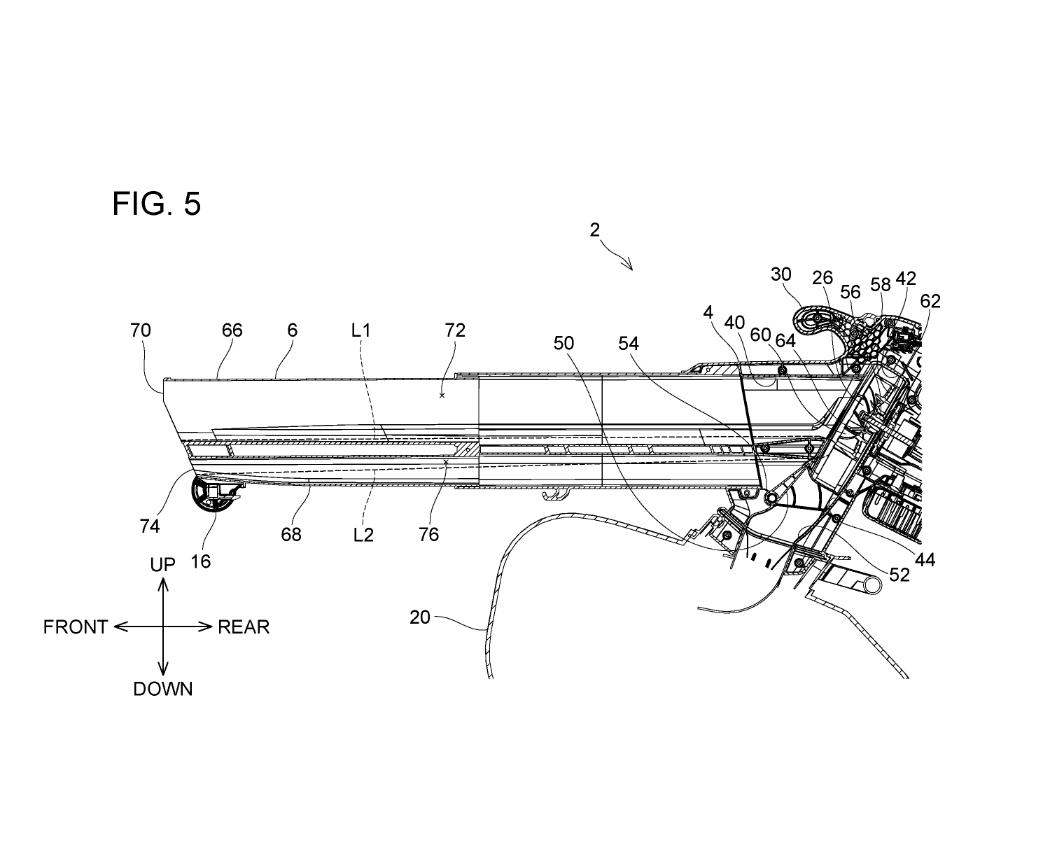

As shown in FIG. 5, the nozzle 6 is attached to the front part of the housing 4. The nozzle 6 is configured to extend in the longitudinal direction (i.e., front-rear direction). The user can change the length of the nozzle 6 by extending and retracting it. The nozzle 6 comprises an air intake nozzle 66 and an air delivery nozzle 68. The air intake nozzle 66 is located above the air delivery nozzle 68. The distal end of the air intake nozzle 66 comprises a first distal opening 70 which communicates the interior space of the air intake nozzle 66 and the exterior space of the blower 2 with each other. The interior space of the air intake nozzle 66 communicates with the interior space of the air intake chamber 40. In this embodiment, a passage from the first distal opening 70 through the air intake nozzle 66 and the air intake chamber 40 to the fan housing chamber 42 will be referred to as “air intake passage 72”. The air intake passage 72 extends in the front-rear direction. The distal end of the air delivery nozzle 68 comprises a second distal opening 74 that communicates the interior space of the air delivery nozzle 68 and the exterior space of the blower 2 with each other. The interior space of the air delivery nozzle 68 communicates with the interior space of the second exhaust chamber 54. In this embodiment, a passage from the fan housing chamber 42 through the second exhaust chamber 54 and the air delivery nozzle 68 to the second distal opening 74 will be referred to as “air delivery passage 76”. The air delivery passage 76 extends in the front-rear direction.

Air that is suctioned into the interior from the exterior of the air intake passage 72 through the first distal opening 70 flows rearward. If the front end of the first distal opening 70 is offset rearward relative to the front end of the collection bag 20, when air is suctioned through the first distal opening 70, the collection bag 20 may be suctioned toward the first distal opening 70 along with the air, and the collection bag 20 may flap. In contrast, in this embodiment, the front end of the first distal opening 70 is offset frontward relative to the front end of the collection bag 20. This can suppress the collection bag 20 from being suctioned toward the first distal opening 70 together with the air when air is suctioned through the first distal opening 70, thereby suppressing the collection bag 20 from flapping.

Air that is discharged from the inside to the exterior of the air delivery passage 76 through the second distal opening 74 flows frontward. If the front end of the second distal opening 74 is offset rearward relative to the front end of the collection bag 20, when air is discharged through the second distal opening 74, the air discharged through the second distal opening 74 may be blown over the collection bag 20, causing the collection bag 20 to flap. In contrast, in this embodiment, the front end of the second distal opening 74 is offset frontward relative to the front end of the collection bag 20. This can suppress air discharged from the second distal opening 74 from being blown over the collection bag 20 when air is discharged through the second distal opening 74, thereby suppressing the collection bag 20 from flapping.

There is no obstruction between the first distal opening 70 and the centrifugal fan 26 inside the air intake passage 72. A first flow passage length L1, which is the shortest flow passage length from the first distal opening 70 to the centrifugal fan 26 with the nozzle 6 lengthened to its maximum, is within a range of 50 mm or more and 850 mm or less, and is for example 470 mm.

There is no obstruction between the second distal opening 74 and the centrifugal fan 26 inside the air delivery passage 76. A second flow passage length L2, which is the shortest flow passage length from the second distal opening 74 to the centrifugal fan 26 with the nozzle 6 lengthened to its maximum, is within a range of 50 mm or more and 850 mm or less, and is for example 470 mm.

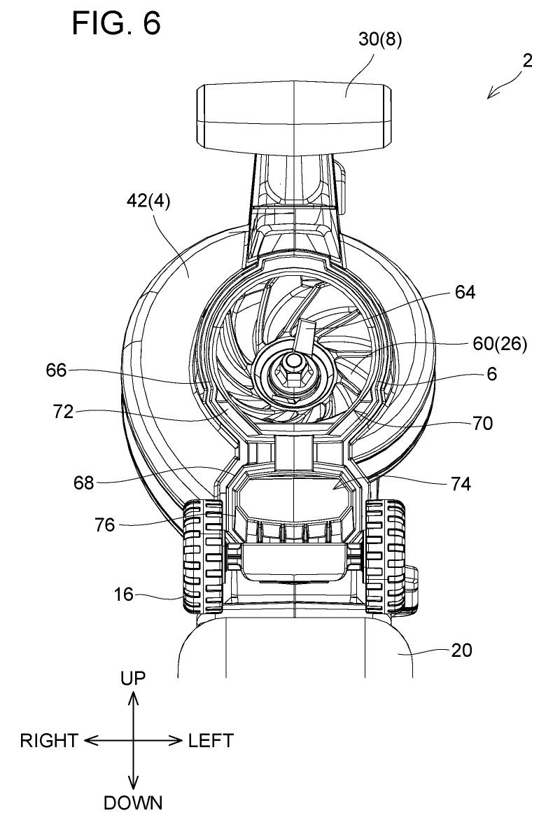

As shown in FIG. 6, the first distal opening 70 has a substantially oval shape. In accordance with this, the cross-sectional shape of the air intake passage 72 is also a substantially oval shape. When the first distal opening 70 is viewed along the front-rear direction (i.e., the direction of extension of the air intake passage 72), the centrifugal fan 26 is visible through the first distal opening 70. Due to this, the flow passage of air from the first distal opening 70 to the centrifugal fan 26 is in a straight line shape, by which the flow resistance is reduced. This allows the suction flow rate of air by the blower 2 to be increased.

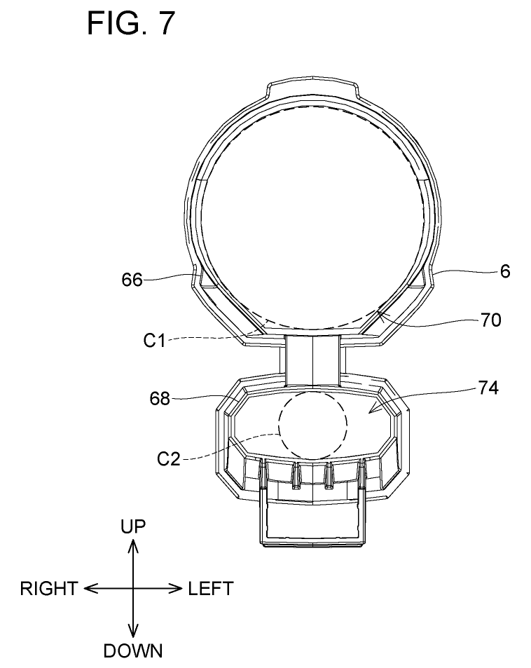

As shown in FIG. 7, an inscribed circle which has the largest diameter among the inscribed circles inscribing the first distal opening 70 when the first distal opening 70 is viewed along the front-rear direction (i.e., the direction of extension of the air intake passage 72) is defined as a first maximum inscribed circle C1. The diameter of the first maximum inscribed circle C1 is within a range of 20 mm or more and 50 mm or less, and is for example 45 mm. By having the diameter of the first maximum inscribed circle C1 within this range, the first distal opening 70 is wide enough not to cause excessive pressure loss, wide enough not to catch debris (such as fallen leaves), and narrow enough not to allow a palm (or arm) of the user to pass therethrough. The diameter of the maximum inscribed circle in the cross section of the air intake passage 72 (see FIG. 6) increases as it separates away from the first distal opening 70 (i.e., toward the rear side). The diameter of the maximum inscribed circle in the cross section of the air intake passage 72 is less than or equal to 50 mm at a position in proximity to the first distal opening 70.

The second distal opening 74 has a substantially rectangular shape. In accordance with this, the cross-sectional shape of the air delivery passage 76 is also a substantially rectangular shape. An inscribed circle which has the largest diameter among the inscribed circles inscribing the second distal opening 74 when the second distal opening 74 is viewed along the front-rear direction (i.e., the direction of extension of the air delivery passage 76) is defined as a second maximum inscribed circle C2. The diameter of the second maximum inscribed circle C2 is within a range of 20 mm or more and 50 mm or less, and is for example 45 mm. By having the diameter of the second maximum inscribed circle C2 within this range, the second distal opening 74 is wide enough not to cause excessive pressure loss and narrow enough not to allow a palm (or arm) of the user to pass therethrough. The diameter of the maximum inscribed circle in the cross section of the air delivery passage 76 (see FIG. 6) increases as it separates away from the second distal opening 74 (i.e., toward the rear side). The diameter of the maximum inscribed circle in the cross section of the air delivery passage 76 is less than or equal to 50 mm at a position in proximity to the second distal opening 74.

As shown in FIG. 2, when the electric motor 22 is driven and the centrifugal fan 26 rotates when the switching lever 14 is in the collection position, a vacuuming operation by the blower 2 is executed. In this case, the front vane portion 60 of the centrifugal fan 26 rotates to suction air from the air intake chamber 40 (i.e., the air intake passage 72) and send that air out to the first exhaust chamber 52. This allows air from outside the blower 2 to flow into the interior of the air intake passage 72 through the first distal opening 70 (see FIG. 5), through the air intake passage 72, the fan housing chamber 42, and the first exhaust chamber 52, and into the interior of the collection bag 20. The blower 2 can use this air flow to collect debris into the collection bag 20. For example, when the user points the first distal opening 70 of the air intake nozzle 66 at the ground, debris on the ground is suctioned into the first distal opening 70 with the air. The debris suctioned into the first distal opening 70 passes through the air intake passage 72 to the fan housing chamber 42 and is crushed by the rotating centrifugal fan 26 and crushing blade 64. The crushed debris is sent out with the air to the first exhaust chamber 52 and collected in the collection bag 20. The rear vane portion 62 of the centrifugal fan 26 rotates to suction air from the motor housing chamber 46 and sends that air out to the first exhaust chamber 52 of the air exhaust chamber 44. The air sent to the first exhaust chamber 52 flows into the interior of the collection bag 20. Due to this, the air outside of the blower 2 flows into the motor housing chamber 46 through a plurality of vent holes 78 (see FIG. 1) formed in a side wall of the housing 4, and then flows through the motor housing chamber 46, the fan housing chamber 42, and the first exhaust chamber 52 to the interior of the collection bag 20. The blower 2 can use this air flow to cool the electric motor 22 and the control device 24 that are housed in the motor housing chamber 46.

As shown in FIG. 3, when the electric motor 22 is driven and the centrifugal fan 26 rotates when the switching lever 14 is in the non-collection position, an air delivery operation by the blower 2 is executed. In this case, the front vane portion 60 of the centrifugal fan 26 rotates to suction air from the air intake chamber 40 (i.e., the air intake passage 72) and sends that air out to the second exhaust chamber 54 (i.e., the air delivery passage 76). Due to this, air from outside the blower 2 flows into the interior of the air intake passage 72 through the first distal opening 70 (see FIG. 5), passes through the air intake passage 72, the fan housing chamber 42, and the air delivery passage 76, and flows out of the blower 2 through the second distal opening 74 (see FIG. 5). The blower 2 can thus perform air delivery directed frontward from the second distal opening 74. The user can use the air delivered from the second distal opening 74 to blow away debris on the ground, for example. The rear vane portion 62 of the centrifugal fan 26 also generates a flow of air to cool the electric motor 22 and the control device 24 as well as during the execution of the vacuuming operation.

### Variants

(See FIG. 2) The blower 2 may comprise a prime mover (e.g., an internal combustion engine) other than the electric motor 22. The electric motor 22 may be a motor other than a brushless motor (e.g., a brushed motor).

(See FIG. 7) The diameter of the first maximum inscribed circle C1 may be less than 20 mm. Similarly, the diameter of the second maximum inscribed circle C2 may be less than 20 mm.

(See FIG. 5) The first flow passage length L1 may be greater than 850 mm. Similarly, the second flow passage length L2 may be greater than 850 mm.

(See FIG. 5) The blower 2 may not have the air delivery passage 76 (i.e., air delivery nozzle 68 and second exhaust chamber 54), the divider 50, and the switching lever 14 (see FIG. 1). Thereby, the blower 2 may be configured not to discharge air (except for air discharge to the collection bag 20).

(See FIG. 6) When the first distal opening 70 is viewed along the front-rear direction (i.e., the direction of extension of the air intake passage 72), the centrifugal fan 26 may not be visible through the first distal opening 70. On the other hand, when the second distal opening 74 is viewed along the front-rear direction (i.e., the direction of extension of the air delivery passage 76), the centrifugal fan 26 may be visible through the second distal opening 74.

(See FIG. 6) The shape of the first distal opening 70 (and the cross-sectional shape of the air intake passage 72) may have a shape other than a substantially oval shape (e.g., a polygonal shape). The shape of the second distal opening 74 (and the cross-sectional shape of the air delivery passage 76) may have a shape other than a substantially rectangular shape (e.g., circular).

(See FIG. 2) The blower 2 may comprise a fan other than the centrifugal fan 26 (e.g., an axial flow fan).

(See FIG. 5) The front end of the first distal opening 70 may be offset rearward relative to the front end of the collection bag 20. The front end of the second distal opening 74 may be offset rearward relative to the front end of the collection bag 20.

### Features of First Embodiment

In one or more embodiments, the blower 2 comprises: the centrifugal fan 26; the electric motor 22 (example of a prime mover) configured to drive the centrifugal fan 26; the housing 4 that houses the centrifugal fan 26 and the electric motor 22; the air intake passage 72 (or air delivery passage 76) (example of an airflow passage) extending from the centrifugal fan 26; and the first distal opening 70 (or second distal opening 74) (example of a distal opening) disposed at the distal end of the air intake passage 72 (or air delivery passage 76) and communicating the interior and the exterior of the air intake passage 72 (or air delivery passage 76). When the centrifugal fan 26 is driven, air is suctioned from the exterior to the interior of the air intake passage 72 through the first distal opening 70 (or air is discharged from the interior to the exterior of the air delivery passage 76 through the second distal opening 74). There is no obstruction between the first distal opening 70 (or the second distal opening 74) and the centrifugal fan 26 inside the air intake passage 72 (or the air delivery passage 76). The diameter of the first maximum inscribed circle C1 (or second maximum inscribed circle C2) of the first distal opening 70 (or second distal opening 74) is less than or equal to 50 mm.

According to the above configuration, the first distal opening 70 (or the second distal opening 74) is so narrow that a palm (or arm) of the user cannot pass through. This can suppress the user's palm (or arm) from entering the air intake passage 72 (or air delivery passage 76) through the first distal opening 70 (or second distal opening 74), by which a user's hand can be suppressed from reaching the centrifugal fan 26. Also, since there is no obstruction between the first distal opening 70 (or second distal opening 74) and the centrifugal fan 26 inside the air intake passage 72 (or air delivery passage 76), object(s) (e.g., dust) can be suppressed from remaining inside the air intake passage 72 (or air delivery passage 76). This can save the user from having to remove object(s) from inside the air intake passage 72 (or air delivery passage 76), by which usability of the blower 2 can be suppressed from deteriorating. Thus, according to the above configuration, a user's hand can be suppressed from reaching the centrifugal fan 26 while the usability of the blower 2 can be suppressed from deteriorating.

In one or more embodiments, the blower 2 comprises: the centrifugal fan 26; the electric motor 22 (example of a prime mover) configured to drive the centrifugal fan 26; the housing 4 that houses the centrifugal fan 26 and the electric motor 22; the air intake passage 72 (or air delivery passage 76) (example of an airflow passage) extending from the centrifugal fan 26; and the first distal opening 70 (or second distal opening 74) (example of a distal opening) disposed at the distal end of the air intake passage 72 (or air delivery passage 76) and communicating the interior and the exterior of the air intake passage 72 (or air delivery passage 76). When the centrifugal fan 26 is driven, air is suctioned from the exterior to the interior of the air intake passage 72 through the first distal opening 70 (or air is discharged from the interior to the exterior of the air delivery passage 76 through the second distal opening 74). There is no obstruction between the first distal opening 70 (or the second distal opening 74) and the centrifugal fan 26 inside the air intake passage 72 (or the air delivery passage 76). The diameter of the maximum inscribed circle in the cross section of the air intake passage 72 (or the air delivery passage 76) at a position in proximity to the first distal opening 70 (or the second distal opening 74) (an example of at least one position of the airflow passage) is less than or equal to 50 mm.

According to the above configuration, the portion of the air intake passage 72 (or the air delivery passage 76) in proximity to the first distal opening 70 (or the second distal opening 74) is so narrow that the palm (or the arm) of the user cannot pass through. This can suppress a user's hand from reaching the centrifugal fan 26. Also, since there is no obstruction between the first distal opening 70 (or second distal opening 74) and the centrifugal fan 26 inside the air intake passage 72 (or air delivery passage 76), object(s) (e.g., dust) can be suppressed from remaining inside the air intake passage 72 (or air delivery passage 76). This can save the user from having to remove the object(s) from inside the air intake passage 72 (or air delivery passage 76), by which the usability of the blower 2 can be suppressed from deteriorating. Thus, according to the above configuration, a user's hand can be suppressed from reaching the centrifugal fan 26 while the usability of the blower 2 can be suppressed from deteriorating.

In one or more embodiments, the diameter of the first maximum inscribed circle C1 (or the second maximum inscribed circle C2) of the first distal opening 70 (or the second distal opening 74) is more than or equal to 20 mm.

If the first distal opening 70 (or the second distal opening 74) is excessively narrow, the pressure loss generated at the first distal opening 70 (or the second distal opening 74) when air flows through the first distal opening 70 (or the second distal opening 74) may increase, and the air discharge flow rate by the blower 2 or the air suction flow rate by the blower 2 may decrease. According to the above configuration, the first distal opening 70 (or second distal opening 74) can be suppressed from becoming excessively narrow, so that the pressure loss generated at the first distal opening 70 (or second distal opening 74) when air flows through the first distal opening 70 (or second distal opening 74) can be reduced. This allows the air discharge flow rate by the blower 2 or the air suction flow rate by the blower 2 to be increased. Furthermore, according to the above configuration, since the first distal opening 70 is reasonably wide, it is possible to suppress suction-target object(s) (e.g., fallen leaves) that are to be suctioned together with the air from being caught in the first distal opening 70 when air is suctioned by the blower 2. This allows the blower 2 to suction the suction-target object(s) smoothly.

In one or more embodiments, the flow passage length from the first distal opening 70 (or the second distal opening 74) to the centrifugal fan 26 inside the air intake passage 72 (or the air delivery passage 76) is less than or equal to 850 mm.

According to the above configuration, the air intake passage 72 (or air delivery passage 76) is compact, allowing the user to easily handle the blower 2.

In one or more embodiments, when the first distal opening 70 is viewed from the exterior of the air intake passage 72 along the direction in which the air intake passage 72 extends, the centrifugal fan 26 is visible through the first distal opening 70.

According to the above configuration, since the airflow passage between the first distal opening 70 and the centrifugal fan 26 is straight, the flow resistance is small. This can increase the air suction flow rate by the blower 2.

In one or more embodiments, when the centrifugal fan 26 is driven, air is suctioned from the exterior to the interior of the air intake passage 72 through the first distal opening 70.

According to the above configuration, when air is suctioned by the blower 2, object(s) (e.g., dust) are actively suctioned into the interior of the air intake passage 72. In this case, effect of having no obstruction between the first distal opening 70 and the centrifugal fan 26 inside the air intake passage 72 (i.e., suppression of object(s) from remaining inside the air intake passage 72) can be significantly demonstrated.

In one or more embodiments, the centrifugal fan 26 is used.

The centrifugal fan 26 is more suitable for generating high pressure airflow than, for example, an axial fan. Therefore, according to the above configuration, the blower 2 that generates a high pressure airflow, i.e., a blower 2 with high suction power, can be easily realized.

In one or more embodiments, the blower 2 further comprises the collection bag 20 configured to be detachably attached to the housing 4 to be disposed such that the collection bag 20 is disposed in the exterior of the housing 4 and to collect an object suctioned together with the air from the exterior to the interior of the air intake passage 72 through the first distal opening 70. The direction in which air is suctioned from the exterior to the interior of the air intake passage 72 through the first distal opening 70 is defined as the first direction (i.e. rear direction). The direction opposite to the first direction (i.e., front direction) is defined as the second direction. When the collection bag 20 is attached to the housing 4, the end of the first distal opening 70 in the second direction (i.e., front end of the first distal opening 70) is offset in the second direction (i.e., front direction) relative to the end of the collection bag 20 in the second direction (i.e., front end of the collection bag 20).

When air is suctioned by the blower 2, the collection bag 20 may flap as the collection bag 20 is suctioned toward the first distal opening 70 together with the air. If the collection bag 20 flaps, the user may feel that the collection bag 20 is in the way. According to the above configuration, when air is suctioned by the blower 2, it can be suppressed that the collection bag 20 is suctioned toward the first distal opening 70 together with air. Since this can suppress the collection bag 20 from flapping, the user can be suppressed from feeling that the collection bag 20 is in the way. Furthermore, according to the above configuration, since the blower 2 is compact, the user can easily handle the blower 2.

### Second Embodiment: Blower 102

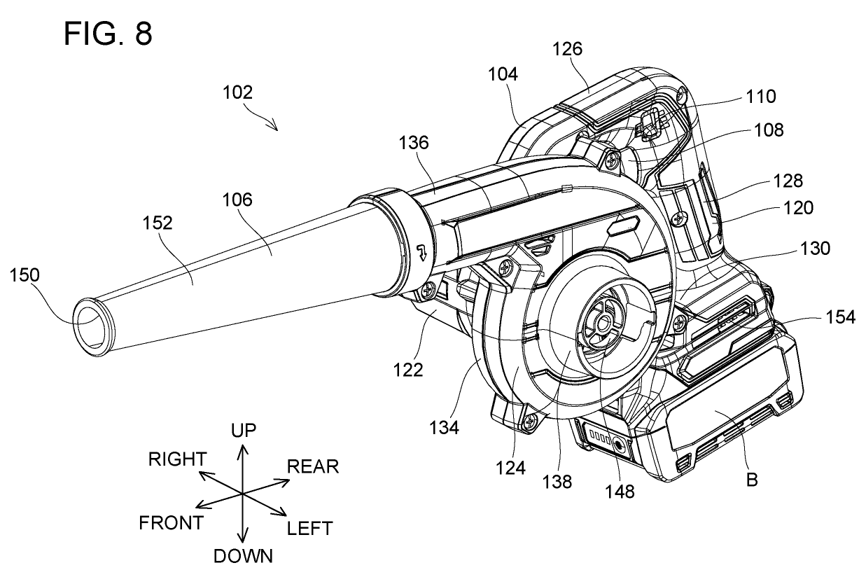

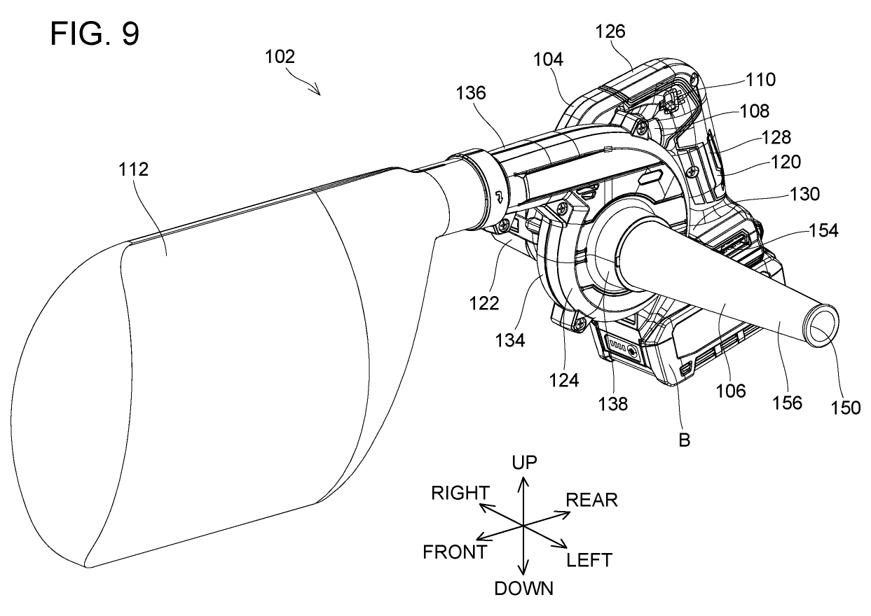

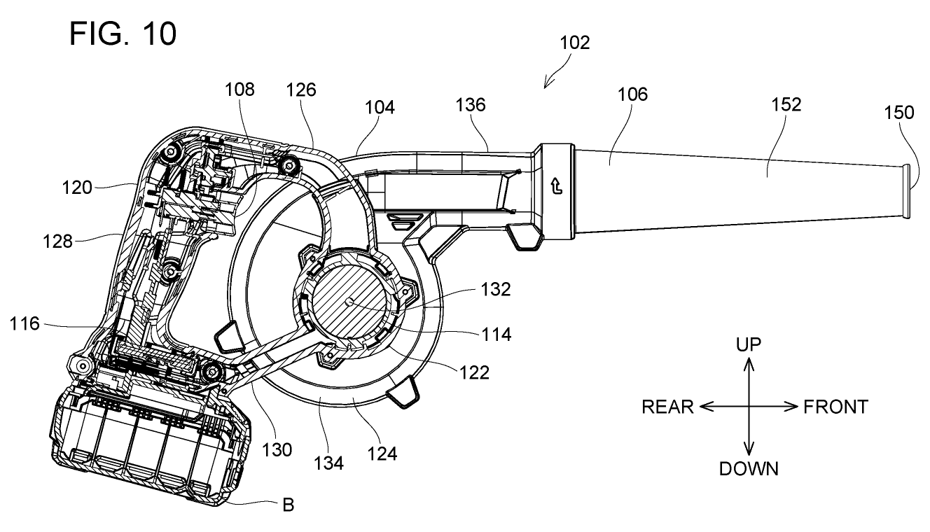

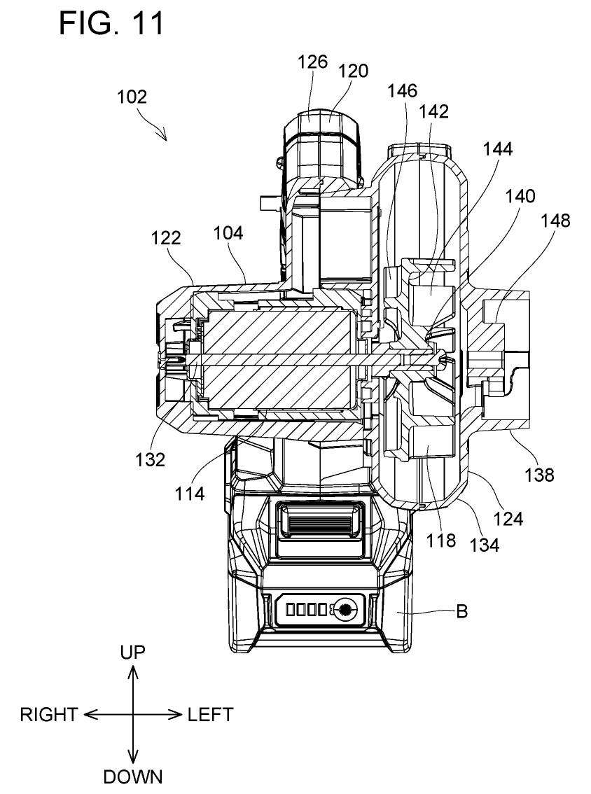

As shown in FIGS. 8 and 9, a blower 102 comprises a housing 104, a nozzle 106, a trigger lever 108, an output adjustment lever 110, a collection bag 112, an electric motor 114 (see FIG. 11), a control device 116 (see FIG. 10), and a centrifugal fan 118 (see FIG. 11). A battery pack B is detachably attached to a lower rear part of the housing 104. The battery pack B contains rechargeable secondary battery cell(s) (e.g., lithium-ion battery cell(s)). The blower 102 operates on electric power supplied from the battery pack B. The blower 102 can selectively switch between an air delivery configuration (configuration shown in FIG. 8) for performing an air discharge operation, in which air is discharged through the nozzle 106, and a vacuum configuration (configuration shown in FIG. 9) for performing a vacuuming operation, in which air is suctioned through the nozzle 106. In this embodiment, a direction along the longitudinal direction of the nozzle 106 when the blower 102 is in the air delivery configuration (configuration shown in FIG. 8) and extending from the housing 104 to the nozzle 106 is defined as the front direction, and the opposite direction thereof is the rear direction. A direction along the longitudinal direction of the nozzle 106 when the blower 102 is in the vacuum configuration (configuration shown in FIG. 9) and extending from the housing 104 to the nozzle 106 is defined as the left direction, and the opposite direction thereof is the right direction. The front-rear and left-right directions are orthogonal to each other. A direction orthogonal to the front-rear and left-right directions and extending from the housing 104 to the battery pack B is the down direction, and the opposite direction thereof is the up direction.

As shown in FIG. 10, the housing 104 comprises a handle 120 that can be grasped by the user, a motor case 122 that houses the electric motor 114, and a fan case 124 that houses the centrifugal fan 118 (see FIG. 11). The fan case 124 is located to the left of the motor case 122. The interior space of the fan case 124 communicates with the interior space of the motor case 122. The interior space of the motor case 122 communicates with the interior space of the handle 120. The handle 120 comprises a first connection portion 126 that extends upward from the upper surface of the motor case 122 and then bends to extend rearward, a gripping portion 128 that extends downward from the rear end of the first connection portion 126, and a second connection portion 130 that extends to a front upper direction from the lower end of the gripping portion 128. The user can carry the blower 102 by grasping the gripping portion 128 with one hand. The control device 116 is housed in a lower part of the gripping portion 128. The control device 116 supplies electric power to the electric motor 114 using power supplied from the battery pack B. The control device 116 controls the output of the electric motor 114 by adjusting the electric power supplied to the electric motor 114. The electric motor 114 is, for example, a brushless motor. The electric motor 114 rotates the shaft 132. The shaft 132 extends across both the motor case 122 and the fan case 124. The shaft 132 is connected to the centrifugal fan 118.

The trigger lever 108 is located on the front surface of the gripping portion 128. The user can operate the trigger lever 108 with the index finger of the hand grasping the gripping portion 128. When the user pushes in the trigger lever 108, electric power is supplied from the battery pack B to the electric motor 114, which drives the electric motor 114 and rotates the centrifugal fan 118. This causes the blower 102 to suction or discharge air. When the user removes his/her hand from the trigger lever 108 and the trigger lever 108 is no longer pushed in, the supply of electric power from the battery pack B to the electric motor 114 is cut off, by which the suction or discharge of air by the blower 102 stops.

As shown in FIG. 8, the output adjustment lever 110 is located on the outer surface of the gripping portion 128. By moving the output adjustment lever 110, the user can switch the output of the electric motor 114 (i.e., rotation speed of the centrifugal fan 118) when the trigger lever 108 is pushed in at multiple levels.

The fan case 124 comprises a volute portion 134, an exhaust pipe 136 extending frontward from the upper part of the volute portion 134, and an air intake pipe 138 extending leftward from the left surface of the volute portion 134. The nozzle 106 is selectively attachable to and detachable from the exhaust pipe 136 or the air intake pipe 138. The nozzle 106 is attached to the exhaust pipe 136 when the blower 102 is in the air delivery configuration (the configuration shown in FIG. 8) and to the air intake pipe 138 when the blower 102 is in the vacuum configuration (the configuration shown in FIG. 9). As shown in FIG. 9, the collection bag 112 is attached to the exhaust pipe 136 when the blower 102 is in the vacuum configuration.

As shown in FIG. 11, the centrifugal fan 118 comprises an axial portion 140, a disk portion 142, a left vane portion 144, and a right vane portion 146. The disk portion 142 extends from the outer peripheral surface of the axial portion 140 outward in the radial direction. The left vane portion 144 protrudes leftward from the left surface of the disk portion 142. The right vane portion 146 protrudes rightward from the right surface of the disk portion 142. The axial portion 140 is fixed to the left part of the shaft 132. Thus, the centrifugal fan 118 rotates in unison with the shaft 132. A filter portion 148 which suppresses foreign matter from entering the fan case 124 from the air intake pipe 138 is defined inside the air intake pipe 138.

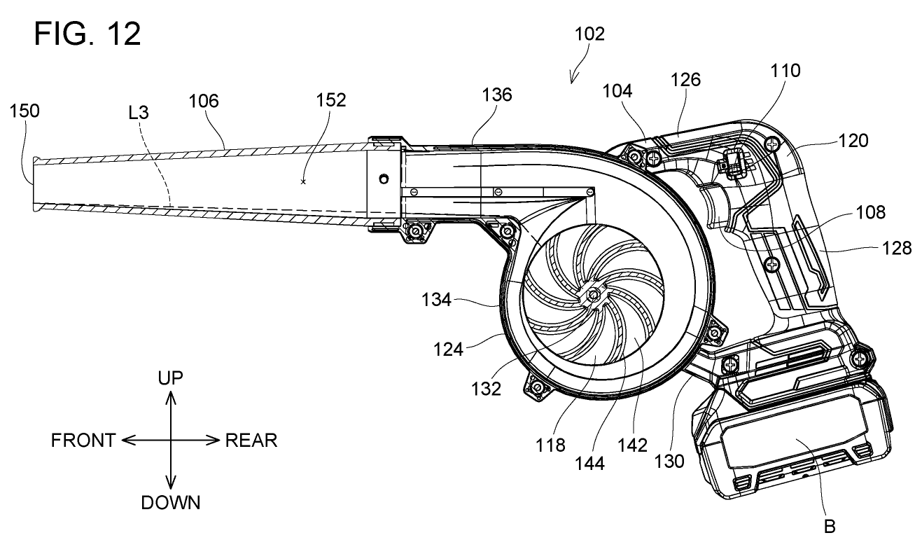

As shown in FIG. 12, when the nozzle 106 is attached to the exhaust pipe 136, the interior space of the nozzle 106 communicates with the interior space of the exhaust pipe 136. The distal end of the nozzle 106 comprises a third distal opening 150 that communicates the interior space of the nozzle 106 and the exterior space of the blower 102 with each other. In this embodiment, a passage from the volute portion 134 through the exhaust pipe 136 and the nozzle 106 to the third distal opening 150 will be referred to as “air delivery passage 152”. The air delivery passage 152 extends in the front-rear direction.

There is no obstruction between the third distal opening 150 and the centrifugal fan 118 inside the air delivery passage 152. A third flow passage length L3, which is the shortest flow passage length from the third distal opening 150 to the centrifugal fan 118, is within a range of 50 mm or more and 850 mm or less, and is for example 135 mm.

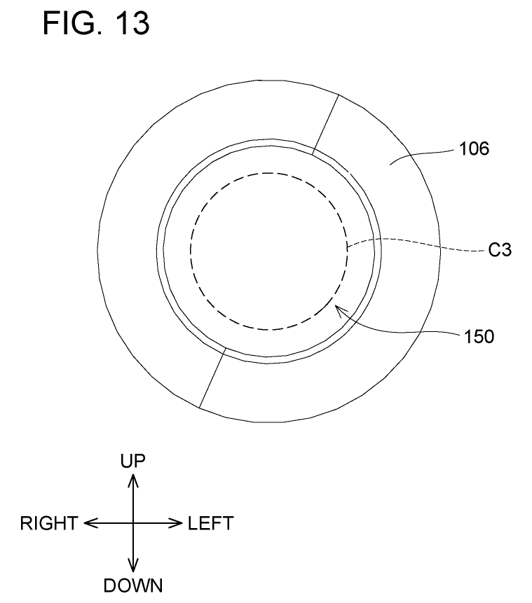

As shown in FIG. 13, the third distal opening 150 comprises a substantially true circular (perfectly circular) shape. In accordance with this, the cross-sectional shape of the nozzle 106 is also a substantially true circular (perfectly circular) shape. An inscribed circle which has the largest diameter among the inscribed circles inscribing the third distal opening 150 when the third distal opening 150 is viewed along the front-rear direction (i.e., the direction of extension of the air delivery passage 152) is defined as a third maximum inscribed circle C3. The diameter of the third maximum inscribed circle C3 is within a range of 20 mm or more and 50 mm or less, and is for example, 42 mm. By having the diameter of the third maximum inscribed circle C3 within this range, the third distal opening 150 is wide enough not to cause excessive pressure loss and narrow enough not to allow the palm (or arm) of a user's hand to pass therethrough. Since the third distal opening 150 of this embodiment has a substantially true circular shape, the diameter of the third maximum inscribed circle C3 corresponds to the inner diameter of the third distal opening 150. The diameter of the maximum inscribed circle in the cross section of the nozzle 106 increases as it separates away from the third distal opening 150 (i.e., toward the rear side). The diameter of the maximum inscribed circle in the cross section of the nozzle 106 is equal to or less than 50 mm at a position in proximity to the third distal opening 150.

As shown in FIG. 12, when the electric motor 114 (see FIG. 11) is driven and the centrifugal fan 118 rotates while the blower 102 is in the air delivery configuration (i.e., configuration where the nozzle 106 is attached to the exhaust pipe 136), the air delivery operation by the blower 102 is performed. In this case, the left vane portion 144 of the centrifugal fan 118 rotates to suction air from outside the blower 102 through the air intake pipe 138 (see FIG. 11) and sends that air outward in the radial direction of the centrifugal fan 118. The air sent outward in the radial direction of the centrifugal fan 118 flows along the inner surface of the volute portion 134 and flows into the exhaust pipe 136. The air having flowed into the exhaust pipe 136 passes through the exhaust pipe 136 and the nozzle 106 and flows out of the third distal opening 150 to the outside of the blower 102. The blower 102 can thus deliver air frontward from the third distal opening 150. The right vane portion 146 of the centrifugal fan 118 shown in FIG. 11 suctions air from the motor case 122 by rotating. Along with this, air from outside the blower 102 flows into the interior of each of the motor case 122 and the handle 120 through vent(s) formed in the motor case 122 (not shown) and vents 154 formed in the lower part of the handle 120 (see FIG. 8). Air having flowed into the interior of the handle 120 passes through the interior of the second connection portion 130 (see FIG. 10) and flows into the motor case 122. The right vane portion 146 sends air suctioned from the motor case 122 outward in the radial direction of the centrifugal fan 118. The air sent outward in the radial direction of the centrifugal fan 118 flows along the inner surface of the volute portion 134 into the exhaust pipe 136 (see FIG. 12), passes through the exhaust pipe 136 and the nozzle 106 (see FIG. 12), and flows out of the blower 102 through the third distal opening 150 (see FIG. 12). The blower 102 in the air delivery configuration can use this airflow to cool the electric motor 114 housed in the motor case 122 and the control device 116 housed in the handle 120.

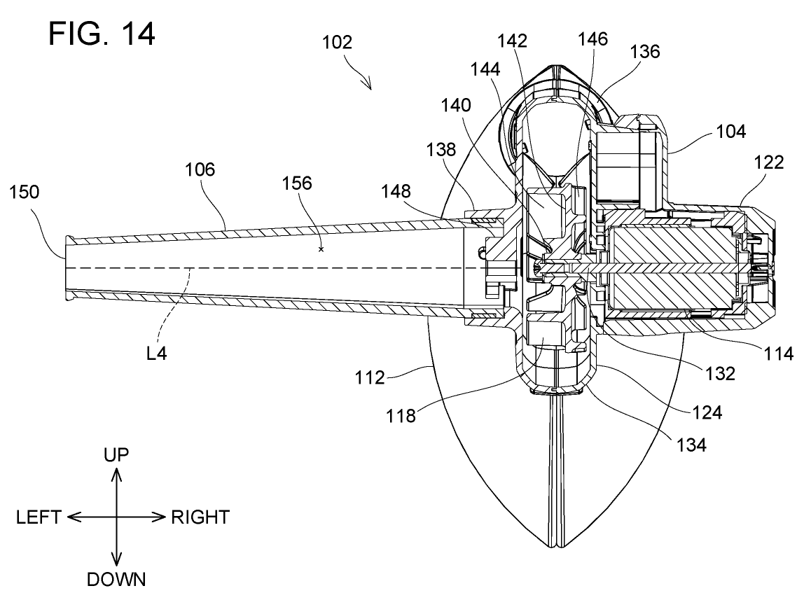

As shown in FIG. 14, when the nozzle 106 is attached to the air intake pipe 138, the interior space of the nozzle 106 communicates with the interior space of the air intake pipe 138. In this embodiment, a passage from the third distal opening 150 through the nozzle 106 and air intake pipe 138 to the volute portion 134 will be referred to as “air intake passage 156”. The air intake passage 156 extends in the left-right direction.

There is an obstruction (i.e., the filter portion 148) between the third distal opening 150 and the centrifugal fan 118 inside the air intake passage 156. However, in another example, there may be no obstruction (i.e., the filter portion 148 may be omitted) in the air intake passage 156. A fourth flow passage length L4, which is the shortest flow passage length from the third distal opening 150 to the centrifugal fan 118, is within a range of 50 mm or more and 850 mm or less, and is for example 50 mm.

When the electric motor 114 is driven and the centrifugal fan 118 rotates while the blower 102 is in the vacuum configuration (i.e., configuration where the collection bag 112 is attached to the exhaust pipe 136 and the nozzle 106 is attached to the air intake pipe 138), the vacuuming operation by the blower 102 is performed. The air flow generated by the centrifugal fan 118 in this case is the same as that of the air delivery operation described above. The blower 102 in the vacuum configuration can use this air flow to collect debris into the collection bag 112. For example, when the user points the third distal opening 150 of the nozzle 106 at the ground, debris on the ground is suctioned into the third distal opening 150 with the air. The debris suctioned into the third distal opening 150 passes through the air intake passage 156 to the fan case 124, where the debris is crushed by the rotating centrifugal fan 118. The crushed debris is sent out with the air into the exhaust pipe 136 and collected in the collection bag 112.

The air that is suctioned from the exterior into the interior of the air intake passage 156 through the third distal opening 150 flows rightward. If the left end of the third distal opening 150 is offset to the right relative to the left end of the collection bag 112, when air is suctioned through the third distal opening 150, the collection bag 112 may be suctioned toward the third distal opening 150 along with the air, and the collection bag 112 may flap. In contrast, in this embodiment, the left end of the third distal opening 150 is offset to the left relative to the left end of the collection bag 112. This can suppress the collection bag 112 from being suctioned toward the third distal opening 150 along with the air when air is suctioned through the third distal opening 150, thereby suppressing the collection bag 112 from flapping.

### Variants

(See FIG. 11) The blower 102 may comprise a prime mover (e.g., an internal combustion engine) other than the electric motor 114. The electric motor 114 may be a motor other than a brushless motor (e.g., a brushed motor).

(See FIG. 13) The diameter of the third maximum inscribed circle C3 may be less than 20 mm.

(See FIG. 13) The shape of the third distal opening 150 (and the cross-sectional shape of the nozzle 106) may have a shape other than a substantially true circular shape (e.g., a polygonal shape).

(See FIGS. 12 and 14.) The third flow passage length L3 may be greater than 850 mm. Similarly, the fourth flow passage length L4 may be greater than 850 mm.

(See FIG. 11) The blower 102 may comprise a fan other than the centrifugal fan 118 (e.g., an axial flow fan).

(See FIG. 14) The left end of the third distal opening 150 may be offset to the right relative to the left end of the collection bag 112.

### Features of Second Embodiment

In one or more embodiments, the blower 102 comprises: the centrifugal fan 118; the electric motor 114 (example of a prime mover) configured to drive the centrifugal fan 118; the housing 104 that houses the centrifugal fan 118 and the electric motor 114; the air delivery passage 152 (or air intake passage 156) (example of an airflow passage) extending from the centrifugal fan 118; and the third distal opening 150 (example of a distal opening) disposed at the distal end of the air delivery passage 152 (or air intake passage 156) and communicating the interior and exterior of the air delivery passage 152 (or air intake passage 156). When the centrifugal fan 118 is driven, air is discharged from the interior to the exterior of the air delivery passage 152 through the third distal opening 150 (or air is suctioned from the exterior to the interior of the air intake passage 156 through the third distal opening 150). There is no obstruction between the third distal opening 150 and the centrifugal fan 118 inside the air delivery passage 152 (or the air intake passage 156). The diameter of the third maximum inscribed circle C3 of the third distal opening 150 is less than or equal to 50 mm.

According to the above configuration, the third distal opening 150 is so narrow that a palm (or arm) of the user cannot pass through. This can suppress the user's palm (or arm) from entering the air delivery passage 152 (or air intake passage 156) through the third distal opening 150, by which a user's hand can be suppressed from reaching the centrifugal fan 118. Also, since there is no obstruction between the third distal opening 150 and the centrifugal fan 118 inside the air delivery passage 152 (or air intake passage 156), object(s) (e.g., dust) can be suppressed from remaining inside the air delivery passage 152 (or air intake passage 156). This can save the user from having to remove object(s) from inside the air delivery passage 152 (or the air intake passage 156), by which the usability of the blower 102 can be suppressed from deteriorating. Thus, according to the above configuration, a user's hand can be suppressed from reaching the centrifugal fan 118 while the usability of the blower 102 can be suppressed from deteriorating.

In one or more embodiments, the blower 102 comprises: the centrifugal fan 118, the electric motor 114 (example of a prime mover) configured to drive the centrifugal fan 118; the housing 104 that houses the centrifugal fan 118 and the electric motor 114; the air delivery passage 152 (or air intake passage 156) (example of an airflow passage); and the third distal opening 150 (example of a distal opening) disposed at the distal end of the air delivery passage 152 (or air intake passage 156) and communicating the interior and the exterior of the air delivery passage 152 (or air intake passage 156). When the centrifugal fan 118 is driven, air is discharged from the interior to the exterior of the air delivery passage 152 through the third distal opening 150 (or air is suctioned from the exterior to the interior of the air intake passage 156 through the third distal opening 150). There is no obstruction between the third distal opening 150 and the centrifugal fan 118 inside the air delivery passage 152 (or the air intake passage 156). The diameter of the maximum inscribed circle in the cross section of the air delivery passage 152 (or air intake passage 156) at a position in proximity to the third distal opening 150 (example of at least one location in the air delivery passage) is less than or equal to 50 mm.

According to the above configuration, the position of the air delivery passage 152 (or the air intake passage 156) in proximity to the third distal opening 150 (an example of at least one position of the airflow passage) is so narrow that a palm (or arm) of a user cannot pass through. This can suppress a user's hand from reaching the centrifugal fan 118. Also, since there is no obstruction between the third distal opening 150 and the centrifugal fan 118 inside the air delivery passage 152 (or air intake passage 156), object(s) (e.g., dust) can be suppressed from remaining inside the air delivery passage 152 (or air intake passage 156). This can save the user from having to remove object(s) from inside the air delivery passage 152 (or the air intake passage 156), by which the usability of the blower 102 can be suppressed from deteriorating. Thus, according to the above configuration, a user's hand can be suppressed from reaching the centrifugal fan 118 while the usability of the blower 102 can be suppressed from deteriorating.

In one or more embodiments, the diameter of the third maximum inscribed circle C3 of the third distal opening 150 is more than or equal to 20 mm.

If the third distal opening 150 is excessively narrow, the pressure loss generated at the third distal opening 150 when air flows through the third distal opening 150 may increase, and the air discharge flow rate by the blower 102 or the air suction flow rate by the blower 102 may decrease. According to the above configuration, the third distal opening 150 can be suppressed from becoming excessively narrow, so that the pressure loss generated at the third distal opening 150 when air flows through the third distal opening 150 can be reduced. This allows the air discharge flow rate by the blower 102 or the air suction flow rate by the blower 102 to be increased. Furthermore, according to the above configuration, since the third distal opening 150 is reasonably wide, it is possible to suppress suction-target object(s) (e.g., fallen leaves) that are to be suctioned together with the air from being caught in the third distal opening 150 when air is suctioned by the blower 102. This allows the blower 102 to suction the suction-target object(s) smoothly.

In one or more embodiments, the length of the flow passage from the third distal opening 150 to the centrifugal fan 118 inside the air delivery passage 152 (or air intake passage 156) is less than or equal to 850 mm.

According to the above configuration, the air delivery passage 152 (or air intake passage 156) is compact, allowing the user to easily handle the blower 102.

In one or more embodiments, when the centrifugal fan 118 is driven, air is suctioned from the exterior to the interior of the air intake passage 156 through the third distal opening 150.

According to the above configuration, when air is suctioned by the blower 102, object(s) (e.g., dust) are actively suctioned into the interior of the air intake passage 156. In this case, effect of having no obstruction between the third distal opening 150 and the centrifugal fan 118 inside the air intake passage 156 (i.e., suppression of object(s) from remaining inside the air intake passage 156) can be significantly demonstrated.

In one or more embodiments, the centrifugal fan 118 is used.

The centrifugal fan 118 is more suitable for generating high pressure airflow than, for example, axial fans. Thus, according to the above configuration, the blower 102 that generates a high-pressure airflow, i.e., a blower 102 with high suction power, can be easily realized.

In one or more embodiments, the blower 102 further comprises the collection bag 112 configured to be detachably attached to the housing 104 such that the collection bag 112 is disposed in the exterior of the housing 104 and to collect an object suctioned together with the air from the exterior to the interior of the air intake passage 156 through the third distal opening 150. The direction in which air is suctioned from the exterior to the interior of the air intake passage 156 through the third distal opening 150 (i.e., right direction) is defined as the first direction. A direction opposite to the first direction (i.e., left direction) is defined as a second direction. When the collection bag 112 is attached to the housing 104, the end of the third distal opening 150 in the second direction (i.e., left end of the third distal opening 150) is offset in the second direction (i.e., left direction) relative to the end of the collection bag 112 in the second direction (i.e., left end of the collection bag 112).

When air is suctioned by the blower 102, the collection bag 112 may flap as the collection bag 112 is suctioned toward the third distal opening 150 along with the air. If the collection bag 112 flaps, the user may feel that the collection bag 112 is in the way. According to the above configuration, when air is suctioned by the blower 102, it can be suppressed that the collection bag 112 is suctioned toward the third distal opening 150 together with the air. Since this can suppress the collection bag 112 from flapping, the user can be suppressed from feeling that the collection bag 112 is in the way. Furthermore, according to the above configuration, since the blower 102 becomes compact, the user can easily handle the blower 102.

What is claimed is:

1. A blower comprising:
a fan;
a prime mover configured to drive the fan;
a housing that houses the fan and the prime mover;
an airflow passage extending from the fan; and
a distal opening disposed at a distal end of the airflow passage and communicating an interior and an exterior of the airflow passage with each other,
wherein
when the fan is driven, air is discharged from the interior to the exterior of the airflow passage through the distal opening, or air is suctioned from the exterior to the interior of the airflow passage through the distal opening,
there is no obstruction between the distal opening and the fan inside the airflow passage, and
a diameter of a maximum inscribed circle of the distal opening is less than or equal to 50 mm.

2. A blower comprising:
a fan;
a prime mover configured to drive the fan;
a housing that houses the fan and the prime mover;
an airflow passage extending from the fan; and
a distal opening disposed at a distal end of the airflow passage and communicating an interior and an exterior of the airflow passage with each other,
wherein
when the fan is driven, air is discharged from the interior to the exterior of the airflow passage through the distal opening, or air is suctioned from the exterior to the interior of the airflow passage through the distal opening,
there is no obstruction between the distal opening and the fan inside the airflow passage, and
a diameter of a maximum inscribed circle in a cross section of at least one position of the airflow passage is less than or equal to 50 mm.

3. The blower according to claim 1, wherein the diameter of the maximum inscribed circle is more than or equal to 20 mm.

4. The blower according to claim 1, wherein a length of a flow passage from the distal opening to the fan inside the airflow passage is less than or equal to 850 mm.

5. The blower according to claim 1, wherein when the distal opening is viewed from the exterior of the airflow passage along a direction in which the airflow passage extends, the fan is visible through the distal opening.

6. The blower according to claim 1, wherein when the fan is driven, air is suctioned from the exterior to the interior of the airflow passage through the distal opening.

7. The blower according to claim 6, wherein the fan is a centrifugal fan.

8. The blower according to claim 6, further comprising a collection bag configured to be detachably attached to the housing such that the collection bag is disposed in the exterior of the housing and to collect an object suctioned together with air from the exterior to the interior of the airflow passage through the distal opening,
wherein
a direction in which air is suctioned from the exterior to the interior of the airflow passage through the distal opening is defined as a first direction,
a direction opposite to the first direction is defined as a second direction, and
when the collection bag is attached to the housing, an end of the distal opening in the second direction is offset in the second direction relative to an end of the collection bag in the second direction.

9. The blower according to claim 3, wherein a diameter of a maximum inscribed circle in a cross section of at least one position of the airflow passage is less than or equal to 50 mm,
a length of a flow passage from the distal opening to the fan inside the airflow passage is less than or equal to 850 mm,
when the distal opening is viewed from the exterior of the airflow passage along a direction in which the airflow passage extends, the fan is visible through the distal opening,
when the fan is driven, air is suctioned from the exterior to the interior of the airflow passage through the distal opening,
the fan is a centrifugal fan,
the blower further comprises a collection bag configured to be detachably attached to the housing such that the collection bag is disposed in the exterior of the housing and to collect an object suctioned together with air from the exterior to the interior of the airflow passage through the distal opening,
a direction in which air is suctioned from the exterior to the interior of the airflow passage through the distal opening is defined as a first direction,
a direction opposite to the first direction is defined as a second direction, and
when the collection bag is attached to the housing, an end of the distal opening in the second direction is offset in the second direction relative to an end of the collection bag in the second direction.
